(19) United States
(12) Patent Application Publication
(10) Pub. No.: US 2026/0193059 A1
(43) Pub. Date: Jul. 9, 2026

(54) ELEVATOR SYSTEM WITH DOOR OPERATOR TRANSLATOR (DOT) AND ASSOCIATED METHODS

(71) Applicant: SOLUTIONS INNOVATION TECHNOLOGY LLC., Orlando, FL (US)

(72) Inventor: Wagner J. LIPNHARSKI, Orlando, FL (US)

(21) Appl. No.: 19/428,650

(22) Filed: Dec. 22, 2025

Related U.S. Application Data
(60) Provisional application No. 63/741,544, filed on Jan. 3, 2025.

(51) Int. Cl. B66B 13/14; B66B 3/00; B66B 11/00; B66B 13/22

(52) U.S. Cl. CPC B66B 13/146; B66B 3/004; B66B 13/22; B66B 11/0015; B66B 11/0025

(57) ABSTRACT

An elevator system includes an elevator car movable within a hoistway in a building in response to operation of a hoisting system coupled thereto, with the elevator car including an elevator door. An elevator controller manages elevator functions including directing movement of the elevator car via the hoisting system, and to control movement of the elevator door via commands sent over a serial communications bus. A door operator translator (DOT) is carried by the elevator car and receives the commands from the elevator controller sent over the serial communications bus and translates the commands to discrete output signals. The door operator translator includes discrete hardwired inputs and outputs. A door operator is carried by the elevator car and is coupled to the door operator translator via the discrete hardwired inputs and outputs and is configured to move the elevator door in response to the discrete output signals received over the discrete hardwired outputs.

### CROSS-REFERENCE TO RELATED APPLICATION

The present application claims the benefit of U.S. Provisional Patent Application Ser. No. 63/741,544 filed Jan. 3, 2025, all of which is fully incorporated by reference.

### TECHNICAL FIELD

The present disclosure relates to elevator systems, and, more particularly, to a door operator translator enabling interoperability between older designed elevator controllers and newer designed door operators, and associated methods.

### BACKGROUND

The Dover Elevator Company produced elevators starting in 1955, and was later acquired by ThyssenKrupp in 1999, which was officially renamed TK Elevator (TKE) in 2021. The Dover Elevator company introduced the Dover microprocessor control (DMC) system for hydraulic elevators, with the DMC elevator controller being one of the most popular controllers throughout the 1980s and 1990s. It is estimated that 80,000 DMC elevator controllers are still in service. Each DMC elevator controller communicates with a corresponding DMC door operator allowing for precise door timing and safety.

However, the DMC platform is over 30 years old and has been declared end-of-life by the manufacturer, creating long-term maintenance and parts-availability challenges for building owners and service organizations. In the original DMC installations, the DMC elevator controller and the DMC door operator exchange polling, commands and status over a serial communications bus based on the RS-485 standard.

Over time the elevator industry's product lines and communication practices have evolved. Many contemporary door operators (and retrofit replacement packages) use discrete dedicated wires for each signal rather than the legacy DMC serial communications protocol.

Vendors and aftermarket suppliers now offer door operator replacements that support discrete hardwired signals. For example, the GAL MOVFR2 door operator provided by G.A.L. Manufacturing Corp. uses discrete hardwired signals, and accepts universal inputs, which makes it compatible with a wide range of elevator controllers, particularly in modernization projects. Nevertheless, simple direct replacement is often not possible because the electrical and protocol expectations differ between legacy DMC elevator controllers and newer door operators.

### SUMMARY

An elevator system includes an elevator car movable within a hoistway in a building in response to operation of a hoisting system coupled thereto, with the elevator car including an elevator door. An elevator controller is configured to manage elevator functions including directing movement of the elevator car via the hoisting system, and to control movement of the elevator door via commands sent over a serial communications bus. A door operator translator (DOT) is carried by the elevator car and is configured to receive the commands from the elevator controller sent over the serial communications bus, and to translate the commands to discrete output signals. The door operator translator includes discrete hardwired inputs and outputs. A door operator is carried by the elevator car and is coupled to the door operator translator via the discrete hardwired inputs and outputs, and is configured to move the elevator door in response to the discrete output signals received over the discrete hardwired outputs.

The elevator controller may be carried by the elevator car. Power may be provided to the elevator controller and the door operator from a machine room within the building. Alternatively, the elevator controller may be mounted in the machine room. The door operator translator may receive power from the door operator.

The door operator translator includes a communications module configured to communicate with the elevator controller over a serial communications bus. A microcontroller is coupled to the communications module and is configured to receive commands from the elevator controller sent over the serial communications bus, and to translate the commands to discrete output signals. An output driver module is coupled to the microcontroller and is configured to provide the discrete output signals over discrete hardwired outputs to the door operator. An input module is coupled to the microcontroller and is configured to receive discrete input signals over discrete hardwired inputs from the door operator.

The discrete input signals received by the input module includes a door closed limit, a door open limit, a door reopen, a gate switch status, and power. The discrete output signals provided by the output module include a door open, a door close and nudge the door to close.

The door operator translator includes a voltage regulator to convert DC power received from the door operator to a lower DC power level to power the microcontroller, the communications module, the input module, and the output driver module. The door operator translator may include an exposed service connector coupled to the microcontroller for access by a technician.

Another aspect is directed to a door operator translator for an elevator system having an elevator controller and a door operator. The door operator translator includes a communications module configured to communicate with the elevator controller over a serial communications bus. A microcontroller is coupled to the communications module and is configured to receive commands from the elevator controller sent over the serial communications bus, and to translate the commands to discrete output signals. An output driver module is coupled to the microcontroller and is configured to provide the discrete output signals over discrete hardwired outputs to the door operator. An input module is coupled to the microcontroller and is configured to receive discrete input signals over discrete hardwired inputs from the door operator.

Yet another aspect is directed to a method for operating a door operator translator within an elevator system having an elevator controller and a door operator. The method includes operating a communications module to communicate with the elevator controller over a serial communications bus. A microcontroller coupled to the communication module is operated to receive commands from the elevator controller sent over the serial communications bus, and to translate the commands to discrete output signals. The method further operating an output driver module coupled to the microcontroller and configured to provide the discrete output signals over discrete hardwired outputs to the door operator, and operating an input module coupled to the microcontroller and configured to receive discrete input signals over discrete hardwired inputs from the door operator, and

### BRIEF DESCRIPTION OF THE DRAWINGS

FIG. 1 is a block diagram of an elevator system with a door operator translator (DOT) in which various aspects of the disclosure may be implemented.

FIG. 2 is a functional block diagram of the door operator translator illustrated in FIG. 1.

FIG. 3 is a more detailed block diagram of the door operator translator illustrated in FIG. 1.

FIG. 4 is a perspective view of the door operator translator illustrated in FIG. 1.

FIG. 5 is a flowchart for operating the door operator translator illustrated in FIG. 1.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

The microprocessor controlled DMC system for hydraulic elevators uses a DMC elevator controller and a corresponding DMC door operator. The DMC elevator controller and the corresponding DMC door operator communicate using a serial communications protocol.

Because many DMC elevator controllers remain in active service but replacement door operators or modern door equipment use incompatible interfaces (i.e., discrete hardwired signals), there is a need for an interface device that translates between the DMC's legacy serial communications protocol and the discrete hardwired interfaces used by modern door operators.

Modernizing the overall DMC platform is rather costly, where hundreds of thousands of dollars are needed to replace older installations with new complete elevator models. Such a translator device would permit reuse of existing DMC elevator controllers and reduce the cost and scope of full controller replacements.

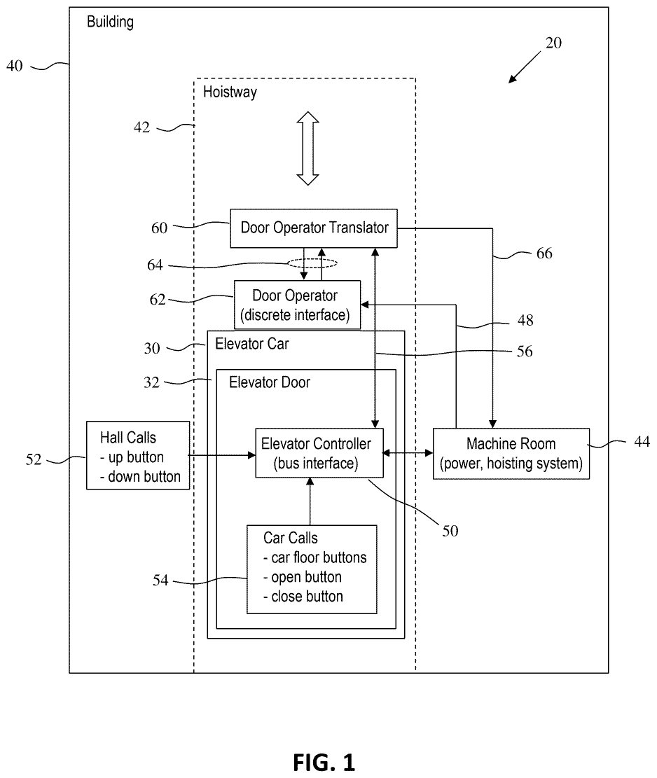

Referring initially to FIG. 1, an elevator system 20 with a door operator translator 60 will be discussed. The door operator translator 60 is not limited to the DMC controller and the GAL MOVFR2 door operator as discussed above. The door operator translator 60 is configured to allow interoperability between elevator controllers in general that use a serial communications protocol and replacement door operators using discrete wire controls.

The elevator system 20 includes an elevator car 30 movable along a hoistway 42 in a building 40. The hoistway 42 may also be referred to as an elevator shaft. A machine room 44 is located adjacent to the hoistway 42, and provides a hoisting system for lifting and lowering the elevator car 30. The machine room 44 also provides electrical power for the elevator system 20.

The machine room 44 is on the lowest level of the building 40 when the hoisting system is a hydraulic hoisting system. The hydraulic hoisting system is used in low-rise buildings (2-6 floors). A hydraulic pump is used to push oil into a cylinder, which extends a piston to lift the elevator car 30. To lower the elevator car 30, values release oil back to an oil tank housed in the machine room 44.

Alternatively, the machine room 44 is above the hoistway 42 when the hoisting system is a traction hoisting system. The traction hoisting system is used in mid-rise to high-rise buildings. An electric motor is used to turn a sheave (a big pulley), and steel ropes or belts wrap around the sheave. One end of the ropes are connected to the elevator car 30 and the other end of the ropes are connected to counterweights.

The elevator controller 50 is the “brain” that manages all elevator functions, directing movement, stopping precisely at floors, and controlling the elevator door. The elevator controller 50 is illustrated as being carried by the elevator car 30. In other embodiments, the elevator controller 50 may be located in a fixed location separate from the elevator car 30, such as in machine room 44.

The elevator controller 50 also interfaces with hall calls 52 and car calls 54. Hall calls 52 are requests made via up/down buttons pressed to summon the elevator car 30. The up/down buttons are in the lobby area on each floor of the building 40. Car calls 54 are requests made inside the elevator car 30 via floor buttons to select a floor destination. The floor buttons are mounted in a passenger interface panel along with other buttons, such as open and close buttons.

The elevator controller 50 is configured to operate as a serial communications hub, and is a master device on a serial communications bus 56. The serial communications bus 56 is connected to a door operator translator (DOT) 60 carried by the elevator car 30. The door operator translator 60 is a slave device on the serial communications bus 56. The elevator controller 50 polls the door operator translator 60 by exchanging command and status data over the serial communications bus 56.

The door operator translator 60 in turn interfaces with a door operator 62 via a hardwired interface 64. The door operator 62 is to locally control and monitor the elevator car 30 while communicating door status and receiving commands from the elevator controller 50. The elevator controller 50 decides when the elevator door is to operate, and the door operator 62 decides how the elevator door is to physically move.

The door operator 62 provides dedicated, real-time control of door motors and mechanisms, offloads door motion control from the elevator controller 50, and ensures safe, smooth, and compliant operation of the elevator door 32. As will be described in greater detail below, the door operator translator 60 provides bidirectional protocol conversion to enable interoperability between the elevator controller 50 that uses a serial communication protocol and the door operator 62 that uses hardwired, discrete signals.

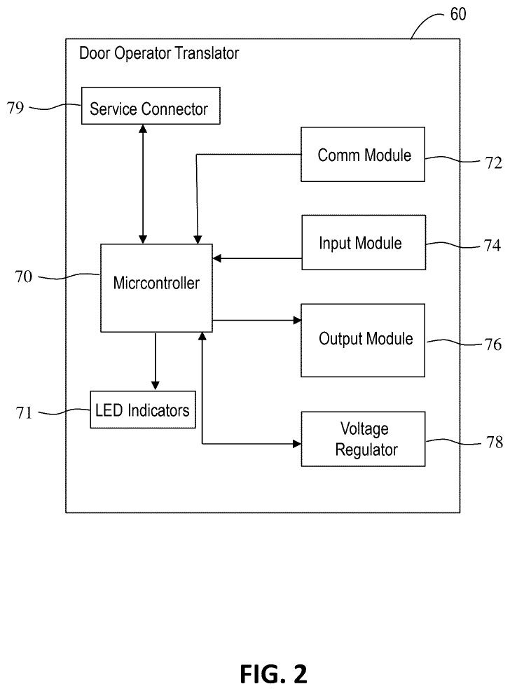

Referring now to FIG. 2, the door operator translator 60 will be discussed in greater detail. The door operator translator 60 has two main functions.

A first function is to use the RS485 network to communicate with the elevator controller 50 over the serial communications bus 56, mimicking a legacy door operator. A legacy door operator is a slave device to the master elevator controller 50. From the point of view of the elevator controller 50, the door operator translator 60 appears as a legacy door operator. The door operator translator 60 receives polling, commands and status requests from the elevator controller 50 over the serial communications bus 56.

Considering the door operator 62 has its own setup for motor speed, acceleration and distances for changing speed, all the configuration data coming from the elevator controller 50 to the door operator translator 60 is ignored. The only functions sent by the elevator controller 50 that require answers, will be transmitted by the door operator translator 60 after it receives the next polling from the elevator controller. The door operator translator 60 will answer as a legacy door operator, sensing status and changes coming from the door operator 62. The door operator translator 60 also receives open/close commands for the elevator door 32, and answers polling and status requests from the elevator controller 50.

A second function is to translate the commands and status requests received from the elevator controller 50 to discrete signals to be received by the door controller 62 over the hardwired interface 64. The hardwired interface 64 includes three discrete outputs to the door operator 62 and five discrete inputs from the door operator 62.

The discrete outputs include an open command 64A, a close command 64B and a close nudge command 64C. The close nudge command 64C instructs the elevator door 32 to close at a reduced speed and at a reduced force, typically after the elevator door 32 has been held open for an extended period of time. The discrete inputs include a door close limit 64D, a door open limit 64E, a door reopen 64F, a gate switch 64G and power 64H. The machine room 44 provides power to the elevator controller 50 and to the door operator 62. The door operator 62 in turn passes the power to the door operator translator 60.

For example, when the door operator translator 60 receives a command to open/close the elevator door 32, it decodes and translates the command for the door operator 62. When a door close command is received, an interface close pin goes low, activating the door operator 62 to do so. Before the elevator door 32 is fully closed, the door operator translator 60 activates an internal relay mimicking the gate switch (output 64G) on the door operator 62. The gate switch detects if the elevator door 32 is closed, and this information is provided by the door operator translator 60 over connection 66 to the machine room 44 before the hoisting system is operated.

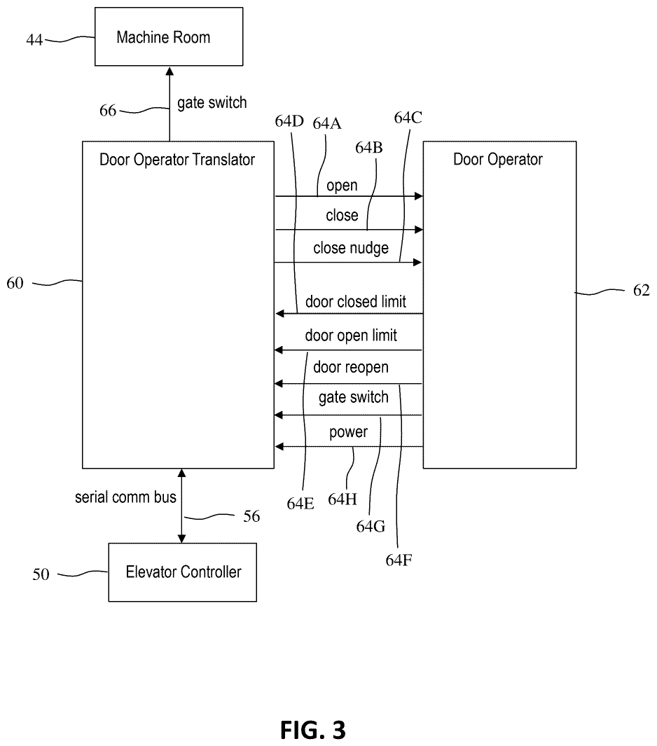

A more detailed block diagram of the door operator translator 60 is provided in FIG. 3. The door operator translator 60 includes a microcontroller 70, which may also be referred to as a processor. In one embodiment, the microcontroller 70 is an 8-bit Atmel ATMEGA 8/88 microcontroller. The microcontroller 70 is supported by a crystal oscillator running at 14.7 MHz, and an ISP interface for programming the microcontroller flash memory in production or as a service upgrade. The microcontroller 70 has 8 kBytes flash memory to hold the programming.

A communications module 72 is coupled to the microcontroller 70, and includes an RS485 transceiver chip for interfacing with the elevator controller 50 via the serial communications bus 56. The RS485 transceiver chip operates in a single mode. The single mode means that the RS485 transceiver chip cannot receive and transmit at the same time, following the standards of the 2 wire RS485 protocol standard, when no two devices can be transmitting at once.

In this case, the master (i.e., elevator controller 50) always has the priority to initiate a transmission asking a slave (i.e., door operator translator 60) to answer when the master enters into a receive mode. A slave only initiates a transmission after being requested by the master to do so.

An input module 72 and an output driver module 74 are connected to the microcontroller 70. The input module 72 receives discrete hardwired inputs from the door operator 62. These discrete inputs include the door closed limit 64D, the door open limit 64E, the door reopen 64F, a gate switch status 64G, and power 64H. The output module 74 provides discrete hardwired outputs to the door operator 62. These discrete outputs include door open 64A, door close 64B and nudge the door to close 64C.

A voltage regulator 78 converts the 24 Vdc received from the door operator 62 to 5 Vdc necessary to supply power to circuitry within the door operator translator 60. A service connector 79 is connected to the microcontroller 70 and is exposed on the door operator translator 60 for easy connection by a technician. The service connector 79 may be a sixteen pin connector.

LED indicators 71 are connected to the microcontroller 70 to provide feedback to a technician servicing or installing the elevator system 20. There are separate LEDs that turn on for door opening, door closing and nudging the door to close instructions sent to the door operator 62.

There is also a pair of LEDs, where one of the LEDs turns on when receiving sync data from the elevator controller 50, and the other LED turns on when transmitting data back to the elevator controller 50. The pair of LEDs both flash simultaneously, once at power on or each 5 seconds (or other predetermined time interval) without network traffic activity. This visual information helps the technician to diagnose and speed up servicing of the elevator system 20.

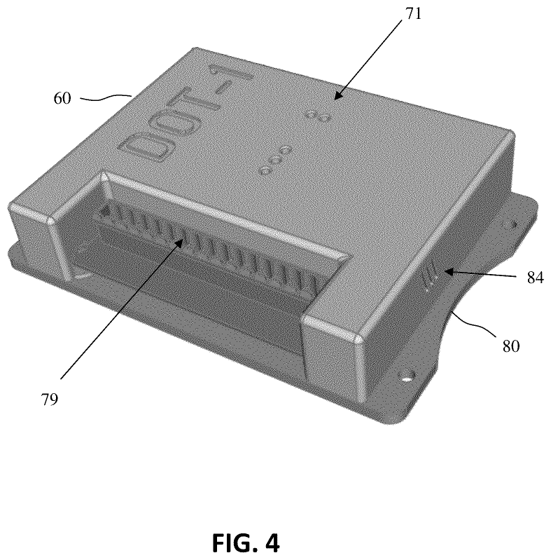

A perspective view of one embodiment of an assembled door operator translator 60 is illustrated in FIG. 4. This embodiment is not to be limited as the door operator translator 60 may be assembled in different styles and configurations. Dimensions of the door operator translator 60 may be about 6 inches in length, 4 inches in width, and about 1.25 inches in height.

The LED indicators 71 consisting of 5 LEDs are visible on an upper surface of the door operator translator 60. The service connector 79 is exposed for easy access by the technician. The door operator translator 60 is stand-alone, no power or operator buttons, and once powered, it starts to operate. The door operator translator 60 may include ventilation slits 84, and mounting holes 82 at the corners of the base 80 for mounting to the elevator car 30.

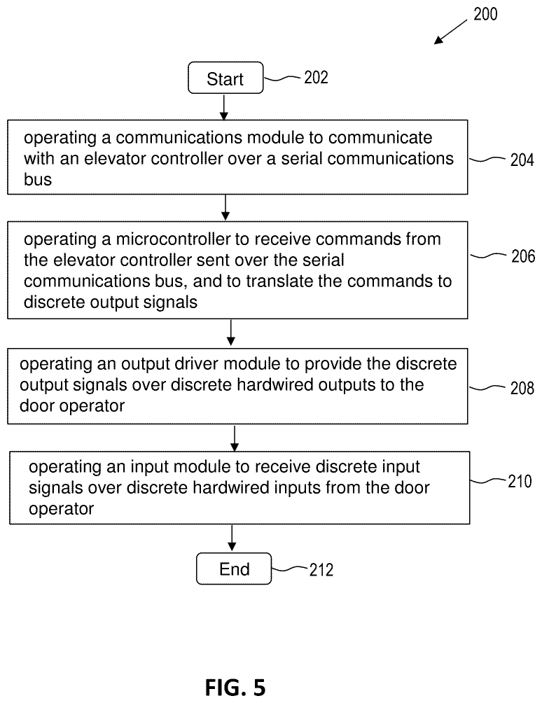

Another aspect is directed to a method for operating the door operator translator 60 as discussed above. Referring now to the flowchart 200 in FIG. 5, from the start (Block 202), the method includes operating a communications module 72 at Block 204 to communicate with the elevator controller 50 over a serial communications bus 56. A microcontroller 70 coupled to the communication module is operated to receive commands at Block 206 from the elevator controller 50 sent over the serial communications bus 56, and to translate the commands to discrete output signals.

The method further includes operating an output driver module 76 coupled to the microcontroller 70 at Block 208 and is configured to provide the discrete output signals over discrete hardwired outputs to the door operator 62. An input module 74 coupled to the microcontroller 70 is operated at Block 210 and is configured to receive discrete input signals over discrete hardwired inputs from the door operator 62. The method ends at Block 212.

The serial communications protocol will now be discussed in more detail. The serial communications protocol is used between the elevator controller 50 and the door operator translator 60, and also between a selector which tracks up/down movement of the elevator car 30.

The door operator translator 60 emulates the legacy door operator (i.e., DMC door operator), understands the protocol, receives polling and commands, and answers status request back to the elevator controller 50. When the door operator translator 60 receives a valid command that is important to open/close/nudge the door, it sends such information to the newer door operator 62 using the discrete control wires.

The newer door operator 62 then exercises the door and informs back to the door operator translator 60 the door position, DCL (door closed), DOL (door open), DR (gate switch), and REOP (reopen due someone putting a hand to block the door while closing). Based on those 4 wires from the newer door operator 62, the door operator translator 60 updates the door status in its memory, and if such status changes, it will transmit such status frame on the next polling from the elevator controller 50. The door operator translator 60 behaves exactly as the legacy door operator would do.

The legacy door operator has a processor on board that understands the serial RS485 half-duplex communication protocol and becomes a part of the computer network in order to receive polling, commands, provide answers, send status, and obey the commands opening/closing the door. A disadvantage of the legacy door operator is that it is not produced anymore, and the electronics become rare on the market (as they fail/burn/etc.) causing them to be expensive.

The newer door operator 62 has a powerful processor onboard, it has nonvolatile memory and it is programmed by the technician using a native display and keyboard for all the necessary parameters of acceleration, speed, stops, torque, etc. The newer door operator 62 does not need the legacy elevator controller 50 (i.e., DMC-1 computer) as with the legacy door operator to store those parameters, and instead, uses just 3 wires in and 4 wires out. This does not require any communication protocol frames, and it makes the communication with the elevator controller 50 easier and simpler. All the door controls are done by the newer door operator 62, as a decentralized brain. The other advantage of the newer door operator 62 is that it is readily available.

Some companies offer a brand new solution for the legacy door operator installation, replacing everything, including the elevator computer, the door operator, the mechanics, valves, oil pumps, etc. This updates the elevator system to a new visual and technology efficient model, but with a cost. Advantage Elevator Inc., for example, offers such a solution at costs exceeding $50 k for a few floors. The update may take weeks, which is a problem if the building only has a single elevator.

By using the door operator translator 60, the legacy door operator can be removed and replaced with a newer door operator 62 without installing all the other machinery, updating the door with new technology, while keeping using the legacy elevator controller 50 that will continue to operate for quite some years. The cost for the door operator translator 60 and the newer door operator 62 is much lower while using the legacy elevator controller 50.

In terms of pooling, the elevator controller 50 sends polling to the door operator translator 60 which is intended for the newer door operator 62. The polling may be frequently, more than once per second, to ask the door operator translator 60 if the newer door operator 62 is there, and the door operator translator 60 answers for the newer door operator 62 by saying “I'm here” or sends anything it wants to send to the elevator controller 50, like status or requests.

As only the master (elevator controller 50) can initiate a conversation, the devices (newer door operator 62, selector) need to wait until the elevator controller 50 sends a polling to their specific address, so then the channel is open and they can answer what is in their queue to transmit. When the elevator controller 50 sends a polling, the door operator translator 60 answers for the newer door operator 62 by saying: “I am alive”.

A “status” frame contains the door position (open/close), and the gate switch position (to allow the car to move if the door is fully closed). For “request” parameters, the legacy door operator memory is lost if power fails, so from time to time, it requests a complete set of parameters from the elevator controller 50 that has a battery backup memory and does not lose configuration parameters easily. The elevator controller 50 works as a cloud for the door operator, stores configuration for speed, acceleration, distances, torque, and much more parameters. These parameters have basically no use for the elevator controller 50, it works just as a non-volatile memory for the legacy door operator.

The elevator controller 50 sends the polling also to the selector that scans where the car is and helps control the car movement. It also sends polling to a possible notebook plugged in the network that a technician can use to read the elevator status, change parameters, etc. Every different possible response could be packed in different frames, byte counts, and value positions within the frame, etc.

In terms of commands, the elevator controller 50 can send a full set of parameters to the legacy door operator at power on, since it knows the legacy door operator lost them. Except for emergencies like fire, the elevator controller 50 cannot control the car by itself. It will always send commands for the legacy door operator based on human commands by buttons, like hall or car calls, like “move to other floor”, or open the door while it is closing, and such.

If a person (a) on the 2nd floor calls the elevator, when it reaches the 2nd floor, it will stop and open the door for a certain period of time, then closes the door and stays quiet, until another person (b) on the 1st floor calls the elevator. Or the person (a) presses the 1st floor inside the car, and the car will move to the 1st floor, stops, and opens the door for people to enter/exit the car.

The open/close commands for the door movements are sent by the elevator controller 50 to the door operator translator 60 which then translates the commands to discrete signals to be received by the newer door operator 62. This is automated based on a sequence of events. If a person enters the car and does not press any other floor to go, the elevator will eventually close the door and wait. The door can be opened by the person pressing “Open” inside the car. The open button is read by the elevator controller 50 and sends an “open command” to the door operator translator 60 which is translated and passed to the newer door operator 62.

Commands are Open, Close or Close Nudge, with the last command being a slow close with low torque in case the door feels something is blocking the door to close. Every command may be packed in a different frame format, byte counts and control values.

As noted above, the door operator translator 60 contains inside the box: a power regulator, a microcontroller 70, voltage level converters and drivers, including the RS485 interface chip. It receives 24V from the newer door operator 62, regulates down to +5 Vdc for the microcontroller 70 and other circuits. The microcontroller 70 reads the output wires from newer door operator 62 through the voltage converters, and updates the door status in its registers. It establishes communication with the elevator controller 50 via an RS485 interface, and emulates the legacy door operator.

Based on the door status and the commands received from elevator controller 50, it can control the output wires to the newer door operator 62 to open/close/nudge the door, and the newer door operator 62 will perform these functions. The RS485 chip contains a terminator resistor, and an RS485 level adjuster to provide better communication without signal reflection on the pair of communication wires. It also contains two MOV (metal oxide varistors) for the pair of communication wires to protect against higher voltage spikes that may happen from time to time.

The microcontroller 70 also has timed interrupts that verify communication faults or reversed wires, and alerts a technician through two LEDs blinking every 3 to 5 seconds, for example. The RS485 wires are polarized (RS485-A and RS485-B). If during an installation or maintenance the technician disconnects the wires and connects them reversed. This will not work and may take a long time to diagnose, but with the door operator translator 60, two LEDs flash for failed communications or reversed wires. The technician will quickly notice and fix the problem.

The door operator translator 60 also has 3 other LEDs, indicating reception of commands, Open, Close or Nudge. The technician will easily see the 3 LEDs and relate to the door exercising the same command. If the door does not move, then the technician can immediately associate the problem to the cable, or to the newer door operator 62 or something mechanical.

The elevator car may have only a front door, or both front and back doors. The doors existence are programmed at the elevator controller 50. Each door requires its own newer door operator 62. The passenger inside the car may press the door open on the front or rear side and that particular door should open, if available. It means in this case, the car has two door operators on top. On the legacy door operator, there is a jumper to select which door the installation represents, front or rear. The legacy door operator changes its communication address in the protocol based on such a jumper, so the elevator controller 50 can send different commands to the front or the back or both.

The same way, the door operator translator 60 has an internal jumper that mimics the selection of front or rear door. Having front and rear doors, the installation will have two newer door operator 62 installed, one for the front door and the other for the rear door. One of the door operator translators 60 will have a jumper while the other door operator translator 60 does not, in order to emulate front or rear doors. In this case, the door operator translator 60 with the jumper will respond to the rear door address, different from the front door address.

Based on the idea to protect a more generic use, the door operator translator 60 can be programmed to communicate with different elevator models and brands, not only DMC-1, the TAC-20 from Thyssenkrupp or even other brands, the other side using discrete wires to talk to door operators like the MOVFR style units.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. An elevator system comprising:
an elevator car movable within a hoistway in a building in response to operation of a hoisting system coupled thereto, with the elevator car including an elevator door;
an elevator controller configured to manage elevator functions including directing movement of the elevator car via the hoisting system, and to control movement of the elevator door via commands sent over a serial communications bus;
a door operator translator (DOT) carried by the elevator car and configured to receive the commands from the elevator controller sent over the serial communications bus, and to translate the commands to discrete output signals, with the door operator translator including discrete hardwired inputs and outputs; and
a door operator carried by the elevator car and coupled to the door operator translator via the discrete hardwired inputs and outputs, and configured to move the elevator door in response to the discrete output signals received over the discrete hardwired outputs.

2. The elevator system according to claim 1 wherein the elevator controller is carried by the elevator car.

3. The elevator system according to claim 1 wherein power is provided to the elevator controller and the door operator from a machine room within the building.

4. The elevator system according to claim 3 wherein the door operator translator receives power from the door operator.

5. The elevator system according to claim 3 wherein the elevator controller is mounted in the machine room.

6. The elevator system according to claim 1 wherein the door operator translator comprises:
a communications module configured to communicate with the elevator controller over the serial communications bus;
a microcontroller coupled to the communications module and configured to receive the commands from the elevator controller sent over the serial communications bus, and to translate the commands to the discrete output signals;
an output driver module coupled to the microcontroller and configured to provide the discrete output signals to the door operator via the discrete hardwired and
an input module coupled to the microcontroller and configured to receive discrete input signals via the discrete hardwired inputs from the door operator.

7. The elevator system according to claim 6 wherein the discrete input signals received by the input module includes a door closed limit, a door open limit, a door reopen, a gate switch status, and power.

8. The elevator system according to claim 6 wherein the discrete hardwired output signals provided by the output module include a door open, a door close and nudge the door to close.

9. The elevator system according to claim 6 wherein the door operator translator comprises a voltage regulator to convert DC power received from the door operator to a lower DC power level to power the microcontroller, the communications module, the input module, and the output driver module.

10. The elevator system according to claim 6 wherein the door operator translator comprises an exposed service connector coupled to the microcontroller for access by a technician.

11. A door operator translator for an elevator system having an elevator controller and a door operator, and comprising:
a communications module configured to communicate with the elevator controller over a serial communications bus;
a microcontroller coupled to the communications module and configured to receive commands from the elevator controller sent over the serial communications bus, and to translate the commands to discrete output signals;
an output driver module coupled to the microcontroller and configured to provide the discrete output signals over discrete hardwired outputs to the door operator; and
an input module coupled to the microcontroller and configured to receive discrete input signals over discrete hardwired inputs from the door operator.

12. The door operator translator according to claim 11 wherein the communications module is configured to receive polling and status requests over the serial communications bus.

13. The door operator translator according to claim 11 wherein the discrete input signals received by the input module includes a door closed limit, a door open limit, a door reopen, a gate switch status, and power.

14. The door operator translator according to claim 11 wherein the discrete output signals provided by the output module includes a door open, a door close and nudge the door to close.

15. The door operator translator according to claim 11 comprises a voltage regulator to convert DC power received from the door operator to a lower DC power level to power the microcontroller, the communications module, the input module, and the output driver module.

16. The door operator translator according to claim 11 comprises an exposed service connector coupled to the microcontroller for access by a technician.

17. The door operator translator according to claim 16 wherein the door operator translator comprises LED indicators coupled to the microcontroller to provide feedback to the technician.

18. The door operator translator according to claim 11 wherein the LED indicators comprise:
a first LED configured to turn on for a door opening command sent to the door operator;
a second LED configured to turn on for a door closing command sent to the door operator; and
a third LED configured to turn on for a nudging the door to close command sent to the door operator.

19. The door operator translator according to claim 18 wherein the LED indicators comprise a fourth LED and a fifth LED that are configured to both flash simultaneously, once at power on or each without network traffic activity after a set period of time.

20. A method for operating a door operator translator within an elevator system having an elevator controller and a door operator, the method comprising:
operating a communications module to communicate with the elevator controller over a serial communications bus;
operating a microcontroller coupled to the communication module to receive commands from the elevator controller sent over the serial communications bus, and to translate the commands to discrete output signals;
operating an output driver module coupled to the microcontroller and configured to provide the discrete output signals over discrete hardwired outputs to the door operator; and
operating an input module coupled to the microcontroller and configured to receive discrete input signals over discrete hardwired inputs from the door operator.
